(19) United States
(12) Patent Application Publication
(10) Pub. No.: US 2007/0102629 A1
(43) Pub. Date: May 10, 2007

(54) Device for detecting non-metallic objects located on a human subject

(76) Inventors: Matthieu Richard, Lyon (FR); Jean-Claude Lehureau, Sainte Genevieve Des Bois (FR); Gerard Cachier, Bures Sur Yvette (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/583,368

(22) PCT Filed: Dec. 8, 2004
(86) PCT No.: PCT/EP04/53328

§ 371 Date: Jun. 19, 2006

(30) Foreign Application Priority Data
Dec. 19, 2003 (FR) 03/15033

(51) Int. Cl. H01J 40/14

(52) U.S. Cl. 250/225

(57) ABSTRACT

The field of the invention is that of devices for detecting objects concealed on human subjects. These devices are more particularly dedicated to the surveillance and protection of airport areas and transport airplanes. Currently, the devices rely either on X-ray detection or on microwave imaging. In the former case, the system can prove hazardous to human beings, and in the other case, the device raises ethical problems. The invention proposes a device whose operation relies on the reflective properties of the microwave signals polarized by the suspect objects that we are seeking to detect. This device can be portable or installed on security gates. This technique is simple to design, inexpensive, does not require any great computing power and is very well suited to the objects to be detected. The complete measurement is extremely quick and requires no sophisticated measuring instrument.

### CROSS-REFERENCE TO RELATED APPLICATIONS

The present Application is based on International Application No. PCT/EP2004/053328, filed on Dec. 8, 2004, which in turn corresponds to FR 03/15033 filed on Dec. 19, 2003, and priority is hereby claimed under 35 USC §119 based on these applications. Each of these applications are hereby incorporated by reference in their entirety into the present application.

### BACKGROUND OF THE INVENTION

1. Field of the Invention

The field of the invention is that of devices for detecting objects concealed on human subjects. These devices are more particularly dedicated to the surveillance and protection of airport areas and transport airplanes, but they can also be positioned at the entrance of protected buildings, controlled access areas or other transport means (ships, trains, etc.) for which access is to be secured.

2. Description of the Prior Art

To ensure the safety of the passengers in the airplanes, cargo hold luggage and hand baggage is checked by X-ray imaging systems. The passengers themselves pass only through a metal-detector gate. Now, it is necessary to detect on the passenger non-metallic objects that present a real danger such as explosives or ceramic arms.

To overcome this security omission, some airports, such as that of Orlando, have put in place experimentally X-ray scanners for the passengers themselves. However, the use of X-rays for a non-medical purpose is prohibited in a large number of countries and in particular in most European states. In practice, this technique presents a real danger to the human being if used regularly.

To overcome the drawbacks of using X-rays, it is possible to take an image of the human body in the field of millimetric electromagnetic waves. In practice, the dangerous objects or materials that we are trying to detect reflect the waves very differently from the way they are reflected by the human body. This means they can easily be detected. This imaging can be done either passively or actively. The passive technique consists in taking an image directly of the body without illuminating it with a particular millimetric source. In contrast to this, the active technique enables an image to be taken by illuminating the body, for example with a known millimetric beam with a precise wavelength.

These techniques have a number of drawbacks. They are costly and systematically installing them in an airport therefore involves considerable investments. Also, the techniques consisting in taking the image of the human body come up against an ethical problem. In practice, since clothes are not very dense and are unconstructed, they are transparent to the millimetric radiation and, consequently, the subject appears nude on the millimetric image. Now, the passenger will not accept being analyzed nude by an operator.

### SUMMARY OF THE INVENTION

The detection device according to the invention resolves the above drawbacks. The proposed device does not take images of the human body, the system simply measures physical characteristics on the surface of the human body and deduces from the measurements the presence or absence of suspect non-metallic objects.

However, the system is capable of roughly locating the position of the suspect object placed on the body. An operator must then check by hand the area indicated by the device.

This technique is simple to design, inexpensive, does not require any great computing power and is very well suited to the objects to be detected. The complete measurement is extremely quick and requires no sophisticated measuring instrument.

More specifically, the subject of the invention is a device for detecting objects placed on a human subject, said device comprising at least
a source for generating a microwave signal comprising means for generating the signal in a known state of polarization;
a horn for sending said signal, said horn illuminating an area of the body of said human subject;
a horn for receiving the signal reflected by said area;
a structure bearing at least the sending horn and the receiving horn;
means of analyzing said reflected signal comprising first means for determining the energy and polarimetric characteristics of the reflected signal, second means for determining from said characteristics the presence of objects placed on said human subject and third means for warning of said presence.

### BRIEF DESCRIPTION OF THE DRAWINGS

The invention will be better understood and other advantages will become apparent from reading the description that follows, given by way of non-limiting example and with reference to the appended figures, in which:

FIG. 1 represents the reflection of an electromagnetic wave on a substantially flat object depending on whether its initial polarization is linearly polarized in two directions called S or P;

FIG. 2 represents the reflection of an electromagnetic wave on a substantially flat object when its initial polarization is linearly polarized at 45° from the preceding polarizations;

FIG. 3 represents the reflected polarizations of FIGS. 1 and 2 on the Poincar\acute{e} sphere;

FIG. 4 represents the reflected polarizations in a simplified representation mode;

FIGS. 5, 6, 7 and 8 represent the variations of three main parameters of the reflected wave as a function of the frequency of the applied signal for different objects detected;

FIG. 9 represents the disposition of the horns for sending and receiving the signal to capture the reflected signal;

FIGS. 10 and 11 represent the sizes of the detection areas called Fresnel areas for two object geometries;

FIG. 12 is a graph giving, for different frequencies and for different object geometries, the size of the detection area;

FIG. 13 represents a general view of the device according to the invention;

FIG. 14 is a theoretical diagram of a gate comprising a device according to the invention;

FIG. 15 represents a theoretical diagram of a portable device according to the invention;

FIGS. 16, 17 and 18 represent the steps for implementing said portable device.

### MORE DETAILED DESCRIPTION

The operating principle of the device according to the invention relies on the optical reflection properties of the objects and living tissues illuminated by a polarized millimetric wave.

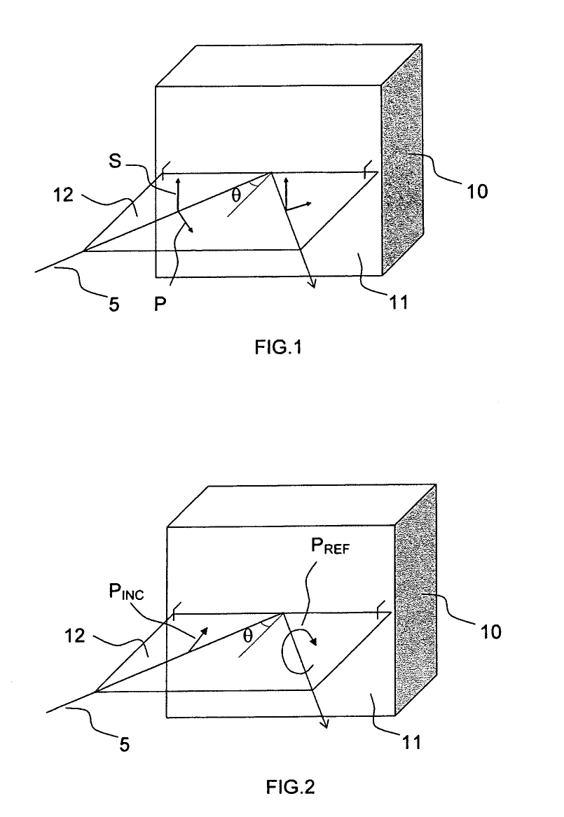

Take a body 10 such as that represented in FIG. 1, delimited by a plane 11 illuminated at a non-zero angle of incidence θ by a polarized wave 5 symbolized by the broken arrow line. The plane of incidence containing the wave 5 and perpendicular to the plane 11 is denoted 12. Two polarizations are retained on the reflection on the plane 11. The first is situated in the plane of incidence 12, the second is perpendicular to the plane of incidence 12. These two polarizations are respectively named P and S.

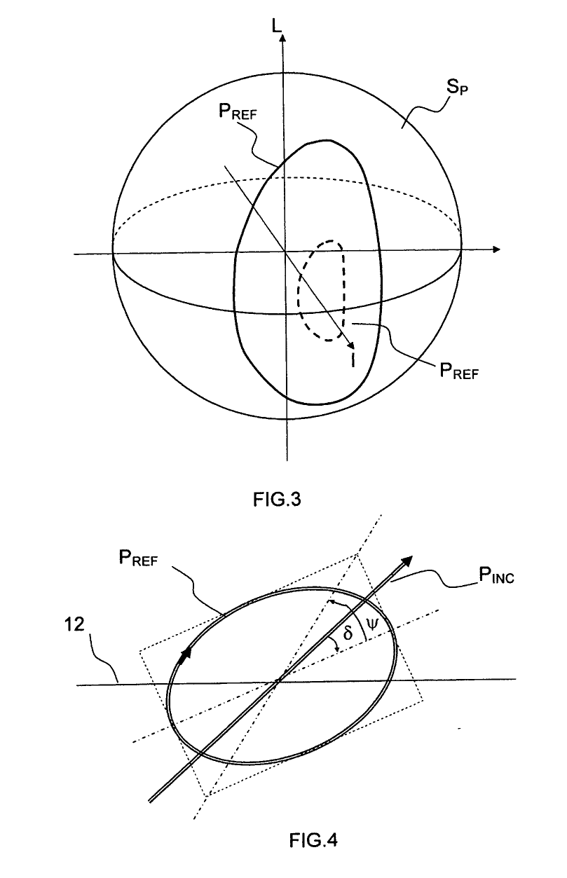

Any other polarization is transformed by the reflection on this plane. For example, a linear polarization wave P_{INC} of any angle will be converted to elliptical polarization P_{REF} in the general case as indicated in FIG. 2. The elliptical polarization P_{REF} is symbolized by a rotating arrow line. The variation in polarization is representative of the optical characteristics of the body. Consequently, by analyzing the polarimetric “signature” of the body, its nature can be identified. Thus, if a microwave signal of known polarization is sent, the nature of the body on which the signal is reflected can be determined by analyzing the reflected signal, provided that the polarization of the signal is neither within the plane of incidence nor perpendicular to said plane of incidence.

The microwaves sending in the range of millimetric or centimetric wavelengths are particularly well suited to detection for two reasons:
the clothes are virtually transparent to this type of wave and the waves are then reflected directly on the human body or the concealed object;
in the microwave domain, the properties of the human body mainly consisting of water are very different from most other materials, so facilitating the detection.

Technically, in the microwave range, it is easy to generate a wave linearly polarized in the required direction. For this, it is sufficient to orient the sending horn at the required angle about the axis of propagation of the microwave signal. The drawback in using a 45° linear polarization is that it is possible for the object to be detected to present a natural polarization oriented along the axis of the incident polarization.

The use of a circularly polarized wave solves this problem. In practice, it is much more difficult to make and conceal under the clothes an object which presents a naturally circular polarization. Only optically active media or media with circular birefringence induced by Faraday effect can have a naturally circular polarization of this type.

More generally, it is possible to use an elliptical polarization which presents the same advantages as the circular polarization but which is easier to generate, especially if a wide range of microwave signals is used.

An elliptically polarized electromagnetic wave is defined by five parameters:
three parameters defining the polarization: orientation of the major axis of the ellipse—ellipticity factor—polarization ratio;
the intensity of the wave;
and the frequency of the microwave signal.

The reflection retains most of the polarization ratio and, of course, the frequency of the wave is known. Three parameters are therefore representative of the polarimetric “signature” of the object. These are the two parameters governing the polarization and intensity of the wave.

Very conventionally, the two polarization parameters can be represented on a Poincare sphere where:
the latitude L corresponds to the ellipticity of the polarization, the poles then represent the two right and left circular polarizations and the equator the linear polarizations and
the longitude 1 is two times the angle of orientation of the major axis of the ellipse.

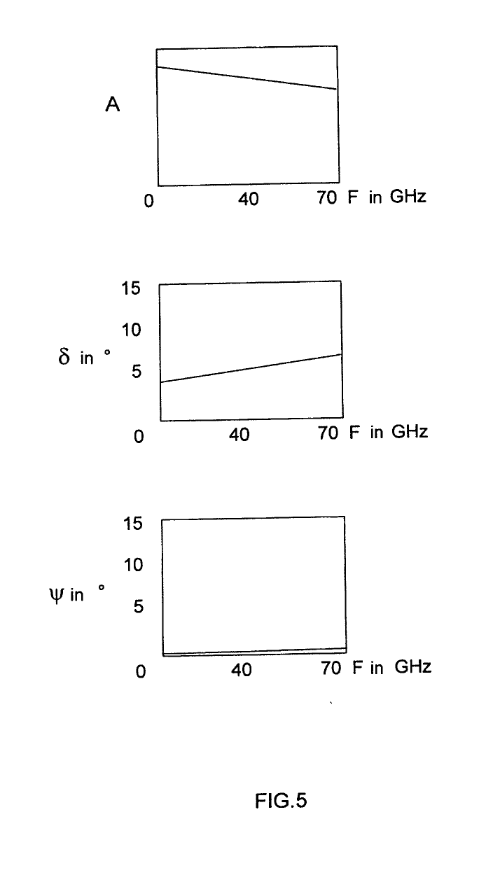

FIG. 3 represents on said Poincaré sphere Sₚ the polarization states P_{REF} of a reflected wave derived from an incident wave polarized at 45° for angles of incidence of 35° and 55° when the thickness of a dielectric body varies from 0 to infinity, the permittivity of this body being equal to 3. By varying the wavelength λ, the polarization state follows a quasi-circular trace centered on the incident polarization state as can be seen in FIG. 3. The solid line trace represents the variations of P_{REF} for the incidence of 55° and the dotted line trace for the incidence of 35°. It is demonstrated that the polarization that is furthest from the equator is achieved for a thickness that is a multiple of λ/12. In contrast to this, the reflection on the skin remains virtually linear even at high incidence. It is therefore easy to detect small thicknesses of dielectric with centimetric waves.

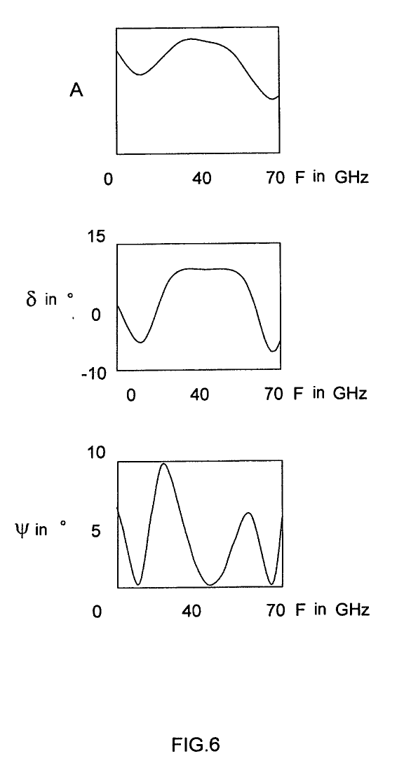

It is also possible to represent the parameters defining the elliptical polarization P_{REF} by two angles δ and Ψ as can be seen in FIG. 4 in the case where the initial polarization P_{INC} is a linear polarization inclined relative to the plane of incidence 12. The angle made by the major axis of the ellipse and the direction of the initial polarization is then designated δ and Ψ designates the angle verifying the following relation:

Tg(Ψ)=A/B with A being the dimension of the minor axis of the ellipse and B being the dimension of the major axis of the ellipse.

An object has a periodic ellipsometric signature that is a function of the signal frequency. These periods are greater if the object is of small optical thickness, the optical thickness being the product of the geometric thickness and the optical index of the material which is equal to the square root of the permittivity of the material. It is therefore fundamentally important to analyze the signal as a function of the frequency and over a wide range of frequencies to obtain a signature that is representative of the object.

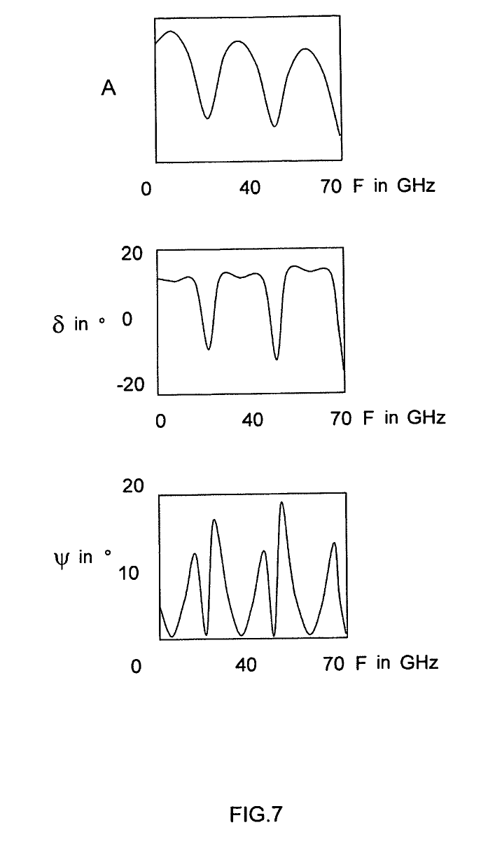

FIGS. 5, 6, 7 and 8 represent the “signature” of a body through the variations in the amplitude of the reflected signal and in the angles δ and Ψ, characteristics of the elliptical polarization as a function of the frequency F of the signal for a range of frequencies varying from a few gigahertz to 70 gigahertz in four different cases. In the four cases, the incident wave is linearly polarized at 45° from the plane of incidence.

In the first case of FIG. 5, the signature is that of a human body. The permittivity of the human body that is mainly made up of water is approximately 40. As can be seen the signature is almost independent of the frequency.

In the second case of FIG. 6, the signature is that of a low permittivity material. It is approximately 2. The thickness of the material is equal to 3 millimeters, which corresponds to the thickness of the objects to be detected. As can be seen in FIG. 6, the variations in the amplitude and ellipticity are great.

In the third case of FIG. 7, the signature is that of a material that is also of low permittivity. It is approximately 3. The thickness of the material is greater, and equal to 5 millimeters. As can be seen in the figure, the variations in the amplitude and ellipticity are significantly greater than in the preceding case.

In the fourth case of FIG. 8, the signature is that of a material of much higher permittivity. It is approximately 7. It corresponds, for example, to that of glass. The thickness of the material is equal to 5 millimeters. As can be seen in the figure, the variations in the amplitude and ellipticity are even greater than in the preceding case.

It is therefore possible, by analyzing the “polarimetric signatures”, to identify the nature of the body and its thickness. This analysis can be done simply by applying different thresholds to the received signals. It is also possible to perform a Fourier analysis of the components of the signal as a function of the signal frequency. Finally, it is also possible to correlate the signals when the latter are noise-affected so as to improve the detection. In practice, the signals representing three different aspects of one and the same signature are necessarily intercorrelated.

When the signature originates not from a single object but from an object and from the human body located beneath, for example in the case of small or elongated objects, then the object introduces a form birefringence which disturbs the initial signature from the human body. In this case, the comparison of the disturbed signature and the initial signature provides a means of detecting the presence of the object.

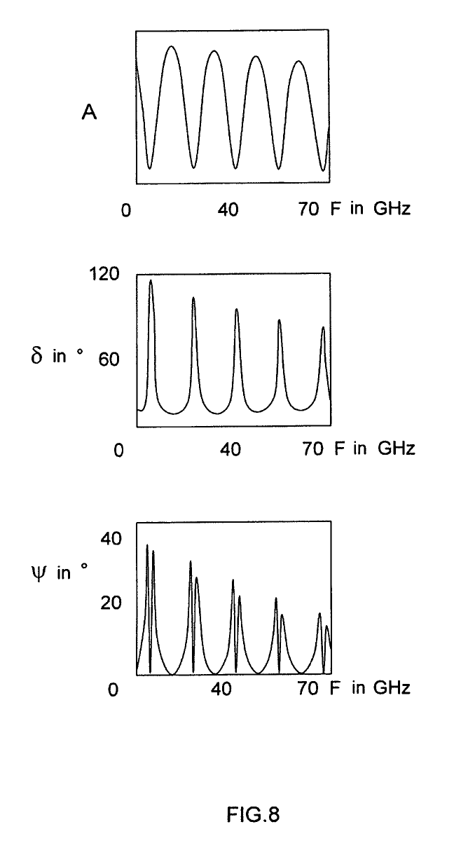

The microwave signal is sent by a one-shot sender and the reflected wave is captured by a non-directional receiver as indicated in FIG. 9. However, since the illuminated bodies are perfectly reflective to the millimetric waves, only the part of the illuminated body that satisfies the geometric laws of reflection and diffraction between the sender and the receiver reflects a radiation that can be captured by the receiver. In particular, the mean angle of the reflected ray is equal to the mean angle of the incident ray. Conventionally, this first part is called Fresnel area. It corresponds to an area within which the diffracted waves are not phase shifted by more than one wavelength λ.

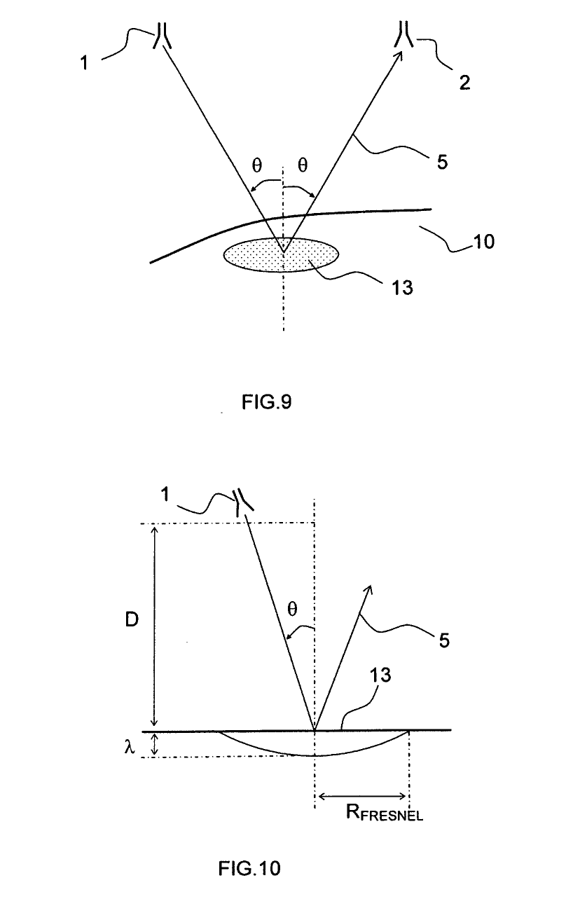

In FIG. 10, the Fresnel area 13 is determined in the case of a flat object illuminated by a sender 1 located at a distance D from the object, said sender 1 sending a radiation 5 at the wavelength λ. In a direction inclined by an angle θ relative to the normal to the object, the Fresnel area 13 is a circular area with a radius R_{FRESNEL} that satisfies the following equation:

$${R}_{FRESNEL} = \frac{\sqrt{λ ( 2 D + λ )}}{cos θ}$$

In FIG. 11, the Fresnel area is determined in the case of an object having a local radius of curvature R, said object being illuminated by a sender 1 located at a distance D from the object, said sender 1 sending a radiation 5 at the wavelength λ. In a direction inclined by an angle θ relative to the normal to the object, the Fresnel area is a circular area with a radius R_{FRESNEL} that satisfies the following equation:

$${R}_{FRESNEL} = \frac{\sqrt{A ( 2 R - A )}}{cos θ} with A = \frac{λ ( 2 D + λ )}{2 ( D + R )}$$

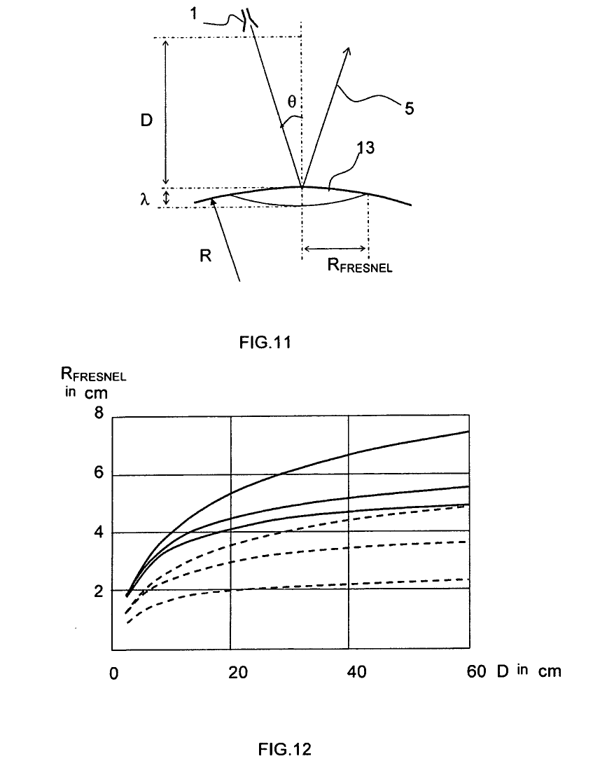

FIG. 12 combines an array of curves giving, according to the distance D between sender and surface of the object, the variation of the Fresnel radius for two signal frequencies and three local radii of curvature R. The solid line curves correspond to a frequency of 30 gigahertz and the dotted line curves correspond to a frequency of 70 gigahertz. For each frequency, the bottom curve corresponds to a radius of curvature R of 15 centimeters, the central curve to a radius of curvature R of 20 centimeters and the top curve to a radius of curvature R of 50 centimeters. These radii of curvature are representative of those that can be found on the human torso. Similarly, the distance between sender and surface of the body is limited to 60 centimeters, which corresponds to the distances routinely used in detection systems of the same type.

The Fresnel radii have sizes between 1 centimeter and 7 centimeters and perfectly correspond to the sizes of the objects to be detected.

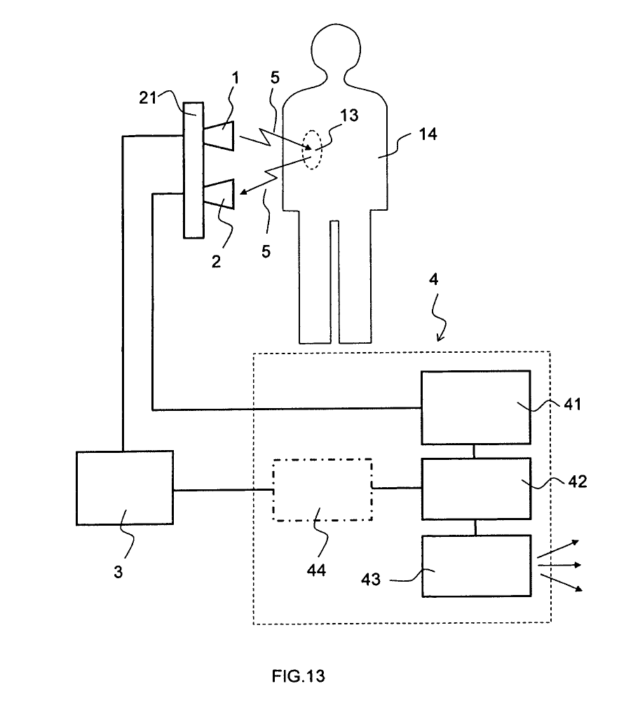

The device according to the invention is represented in FIG. 13. It mainly comprises:
a source 3 for generating a microwave signal 5, said signal generation source comprising means of generating the signal in a known state of polarization;
a horn 1 for sending said signal, said horn illuminating an area 13 of the body of a human subject 14 which may conceal an object;
a horn 2 for receiving the signal reflected by said area;
a structure 21 bearing at least the sending horn 1 and the receiving horn 2;
means 4 of analyzing said reflected signal 5 comprising first means 41 for determining the energy and polarimetric characteristics of the reflected signal, second means 42 for determining from said characteristics the presence of objects placed on said human subject and third means 43 for warning of said presence symbolized by arrows in FIG. 13.

The source 3 for generating the microwave signal comprises means for generating the signal at a variable frequency, said frequency being between a few gigahertz and 70 gigahertz.

The source 1 or the sending horn 2 comprises means for sending said linearly polarized signal, the direction of polarization of the signal possibly being oriented at approximately 45° from the average plane of incidence of the signal on the illuminated area of the body, or for sending a circularly or elliptically polarized signal.

This sending polarization can be kept constant or varied over time in a known manner.

The first means 41 of measuring the polarimetric characteristics of the reflected signal are of different types. When the polarization sent is kept constant, the means 41 are of ellipsometric type, namely that, they allow the main orientation and ellipticity of the received polarization to be measured. There are then various possible techniques for carrying out this measurement. In a first embodiment, the analysis system is said to be “with rotating analyzer”. It is formed by a rotating polarizer placed in front of an intensity detector and means of rotating said polarizer. For example, a microwave horn connected to a microwave guide constitutes a good polarizer, this guide is then connected to a rotating joint providing the swiveling link between the guide and the coaxial connector linked to the intensity detector. The guide and the horn are driven rotation-wise by a direct current motor and the absolute angular position of the horn is measured by an incremental encoder. The motor can also be a stepper motor in cases where there is a long measurement time before the required rotation period, so the orientation of the horn is fixed during the measurement. Based on the measured intensity as a function of the angular position of the receiving horn, the three desired parameters are obtained, namely the received intensity and the two ellipticity parameters of the polarization of the received signal.

The rotating analyzer solution has the advantage of being simple to implement at low cost, but this method has the drawback of involving moving parts. In a second embodiment, the complex amplitude of two orthogonal polarizations that make up the polarization to be analyzed is measured. For this, a so-called orthomode horn is used which gives, on two separate channels, the two vertical and horizontal incident polarizations. Having these two signals, on the one hand each amplitude and then the relative phase shift between these two amplitudes are measured. The measurement can then be done at a repeat frequency measured in kilohertz.

When the polarization sent varies over time, for example when the source or the sending horn comprises means for sending different combinations of parallel and perpendicular polarizations varying over time, then the receiving horn is preferably a horn that can receive a polarization oriented at 45° from the reflection plane. By analyzing the variations of the polarization, as in the preceding case, the ellipsometric characteristics of the area of the body illuminated by the polarized sending wave can be found.

The analysis means can also comprise a synchronous detection 44 symbolized by the dotted line rectangle in FIG. 13. The synchronous detection makes it possible to filter the signal received in a narrow band. It is not necessary if the signal sent is sufficiently strong. The system according to the invention does not require a detection that is accurate phase-wise.

Based on the frequency-dependent ellipsometric characteristics, the presence of objects placed on said human subject can be determined using the analysis means, and an operator can be warned of said presence, either by an audible alarm or by an optical signal, by warning means.

As has been seen, the so-called Fresnel detection area is measured in centimeters. It is sufficient to allow the detection, but naturally insufficient to detect a suspect object on a human body as a whole with only one fixed microwave detector and receiver. It is therefore necessary to have a plurality of sending and receiving horns, the analysis means possibly being common to these different horns. Advantageously, to limit the number of sending and receiving horns, the device comprises means for sending and receiving on one and the same so-called sending/receiving horn. This arrangement makes it possible to reduce the number of sending and receiving sources required by a factor of two.

To provide detection over the whole of the human body, a number of solutions are possible.

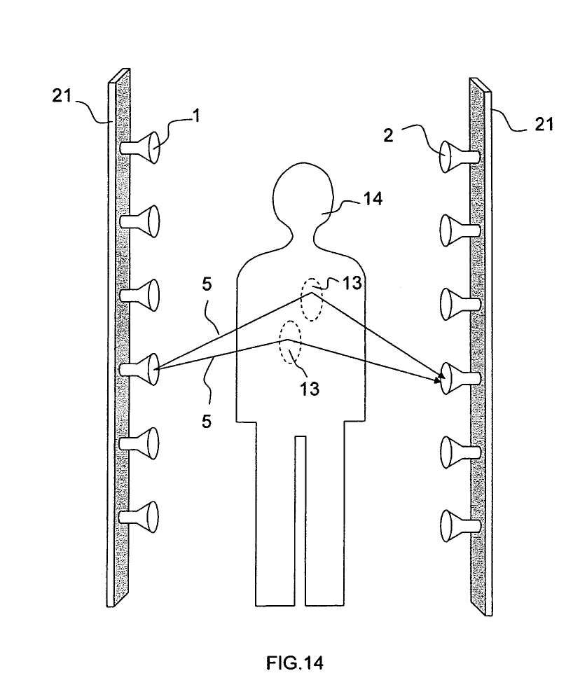

The first solution represented in FIG. 14 consists in having a plurality of senders 1 and receivers 2 on a mechanical structure 21, in the form of a gate of sufficient size, through which the person 14 to be checked passes. The senders 1 send successively the polarized microwave signal 5. The signal seen by each receiver 2 is the sum of various specular reflections originating from different Fresnel areas 13. The angles of incidence differ little from one to the other for these different areas 13 as indicated in FIG. 14. In the absence of a dielectric on the body, these reflections are all linearly polarized and their sum has an amplitude that is strongly dependent on the frequency depending on whether they interfere constructively or destructively, but their polarization depends little on the frequency. The reflection on a dielectric, however, acts strongly on the polarization. It is on this latter criterion that the detection of potentially dangerous objects will be based. Each sender thus covers one or several parts of the human body passing through the gate. By distributing the senders wisely, most of the human body can be covered and effective detection can thus be provided.

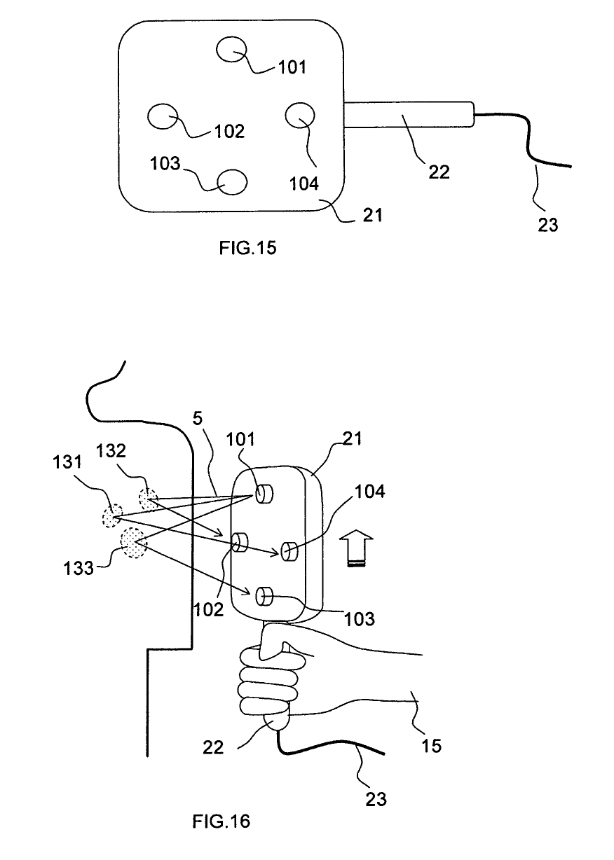

The second solution represented in FIG. 15 consists in having a reduced number of senders and receivers on a mechanical structure 21 in the form of a moving support comprising a handle 22 linked to the source for sending microwave signals and to the analysis means by a lead 23. The operator 15 then moves this support 21 along the body of the person 14 subject to the detection process.

In a particular embodiment given by way of example, the structure comprises four sending/receiving horns, respectively denoted 101, 102, 103 and 104, as indicated in FIG. 15. Said horns are disposed at the peaks of a parallelogram. As an example, operation is as follows:

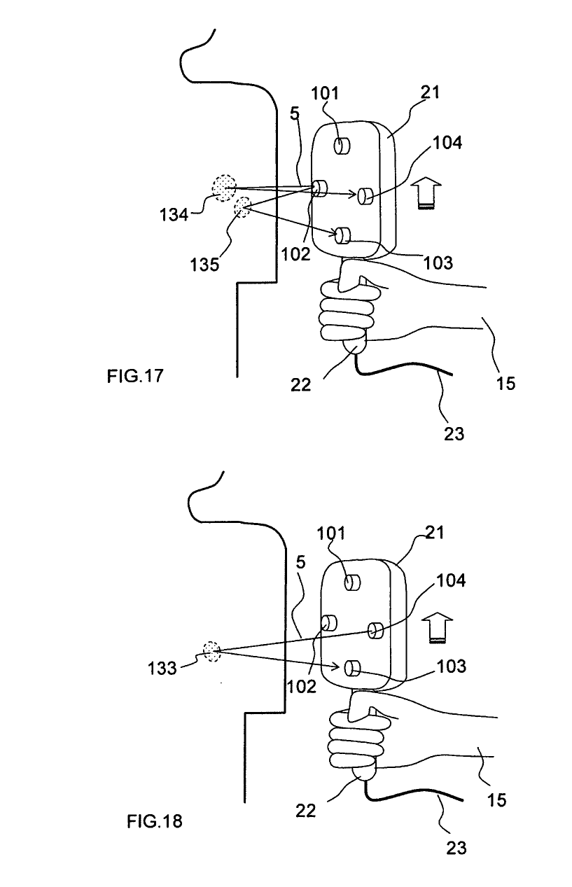

At a given instant, the moving support 21 is held by the operator 15 close to the body 14 to be checked. The sending/receiving horns are then activated sequentially. In a first step represented in FIG. 16, the polarized microwave signal 5 is sent by the first horn 101 used in sending mode and illuminates a large area of the body to be inspected. Three areas of the body 131, 132 and 133 reflect the signal to the second horn 102, the third horn 103 and the fourth horn 104 used in receiving mode as indicated in FIG. 16. In a second step represented in FIG. 17, the polarized microwave signal 5 is sent by the second horn 102 used in sending mode and illuminates the body to be inspected. Two new areas of the body 134 and 135 different from the preceding ones reflect the signal 5 to the third horn 103 and the fourth horn 104 used in receiving mode as indicated in FIG. 17. Finally, in a third step represented in FIG. 18, the polarized microwave signal 5 is sent by the third horn 103 used in sending mode and illuminates the body to be inspected. A new area of the body 136 different from the preceding ones reflects the signal 5 to the fourth horn 104 used in receiving mode as indicated in FIG. 18. Thus, six different measurement areas are covered in three steps using the four sending/receiving horns. Said three measurement steps are carried out in a time of approximately one hundredth of a second. During this brief period, the operator and the human subject can be considered to be immobile.

The device can also comprise means of measuring the temperature of the human body. In practice, a false breast or abdominal prosthesis concealing dangerous objects may not be detectable by the device if this prosthesis is filled with water over its surface. Thus, to overcome this problem, a temperature measurement can be added, in order to discriminate hot skins where the blood is circulating from prostheses concealing dangerous objects, which are naturally colder. It is, in practice, very difficult to regulate a false prosthesis uniformly and at the same temperature as the rest of the body. The temperature measurement does not necessarily require any additional instrument and is performed in approximately one hundredth of a second.

It is essential, of course, for the area to be analyzed by the thermal detector to correspond to the dimensions of the false prostheses to be detected. In effect, these false prostheses have an area normally around 10 centimeters in diameter. In the case of a hand-held detector, the detectors are placed sufficiently close to the body for the area analyzed to correspond to these dimensions and the temperature detection not to require any special adaptation. In the case where the detectors are placed on a gate, they are placed further from the human body. In this case, a temperature detector having a Teflon lens can be used to take the temperature measurement over an area of approximately 10 centimeters in diameter from a distance measured in tens of centimeters.

1-17. (canceled)

18. A device for detecting objects placed on a human subject, said device comprising:
a source for generating a microwave signal comprising means for generating the signal in a known state of polarization, said signal illuminating said area of the body at a non-zero angle of incidence;
a horn for sending said signal, said horn illuminating an area of the body of said human subject;
a horn for receiving the signal reflected by said area;
a structure bearing at least the sending horn and the receiving horn;
means of analyzing said reflected signal comprising first means for determining the energy and polarimetric characteristics of the reflected signal, second means for determining from said characteristics the presence of objects placed on said human subject and third means for warning of said presence.

19. The detection device as claimed in claim 18, comprising means for sending or receiving the signal on one and the same so-called sending/receiving horn.

20. The detection device as claimed in claim 18, comprising a synchronous detection linking the source for generating the microwave signal and the analysis means.

21. The detection device as claimed in claim 18, wherein the source comprises means for generating the signal at a variable frequency, said frequency being between a few gigahertz and 70 gigahertz.

22. The detection device as claimed in claim 18, wherein the source or the sending horn comprises means for sending a linearly polarized signal, the direction of polarization of said signal being oriented at approximately 45° from the average plane of incidence of the signal on the illuminated area of the body.

23. The detection device as claimed in claim 18, wherein the source or the sending horn comprises means for sending a circularly or elliptically polarized signal.

24. The detection device as claimed in claim 18, wherein the source or the sending horn comprises means for sending a polarized signal having different combinations of parallel and perpendicular polarizations varying over time.

25. The detection device as claimed in claim 24, wherein the first means of measuring the polarimetric characteristics of the reflected signal are of ellipsometric type, namely that they allow the main orientation and ellipticity of the received polarization to be measured.

26. The detection device as claimed in claim 25, wherein the first ellipsometric measurement means comprise a microwave polarizer disposed in front of an intensity detector and means of rotating said polarizer.

27. The detection device as claimed in claim 26, wherein the rotation means comprise either a direct current motor or a stepper motor.

28. detection device as claimed in claim 25, wherein the receiving horn is of the orthomode type and that the first measurement means comprise two detectors placed at the output of said receiving horn.

29. The detection device as claimed in claim 24, wherein the first means of measuring the polarimetric characteristics of the reflected signal are a receiving horn for receiving a polarization oriented at 45° from the reflection plane of the illuminated area of the body.

30. The detection device as claimed in claim 18, wherein the mechanical structure is a security gate of a size sufficient to allow the human subject to pass through.

31. The detection device as claimed in claim 18, wherein the mechanical structure is portable and comprises a mechanical part on which are disposed the sending and receiving horns and a handle.

32. The detection device as claimed in claim 31, wherein the horns are of the sending/receiving type.

33. The detection device as claimed in claim 32, wherein the structure comprises four horns disposed at the peaks of a parallelogram.

33. The detection device as claimed in claim 18, comprising means of measuring the temperature of the human body.
